(19) United States
(12) Patent Application Publication
(10) Pub. No.: US 2008/0042861 A1
(43) Pub. Date: Feb. 21, 2008

(54) Safety battery meter system for surgical hand piece

(76) Inventors: Bruno Dacquay, Irvine, CA (US); Cesario P. Dos Santos, Aliso Viejo, CA (US); Casey J. Lind, Irvine, CA (US); James J. Foster, Santa Ana, CA (US)

Correspondence Address: ALCON, IP LEGAL, TB4-8, 6201 SOUTH FREEWAY, FORT WORTH, TX, 76134, US

(21) Appl. No.: 11/504,910

(22) Filed: Aug. 16, 2006

(51) Int. Cl. G08B 21/00

(52) U.S. Cl. 340/636.1

(57) ABSTRACT

A safety meter system for a battery-operated surgical hand piece is disclosed. The system has a controller, a sensor, and a display. The controller is configured to read a charge level from a battery. The sensor is configured to transmit a signal to the controller when the sensor is moved or grasped. The display provides an indication of a status of the battery. When the controller receives the signal from the sensor, the controller is energized, reads the status from the battery, and displays the status on the display. After a period of time after the status is displayed, the controller and the display are turned off.

### FIELD OF THE INVENTION

The present invention relates to a safe battery meter system for surgical hand pieces and more particularly to a battery meter for determining the charge level of a battery for the safe operation of surgical hand pieces.

### BACKGROUND OF THE INVENTION

Many operations performed today involve the use of electrically-powered surgical tools. A surgical tool is usually in the form a hand piece that can be held and manipulated by a surgeon during an operation. Traditionally, each hand piece also has a cable that attaches to the main console of a surgical machine. In this manner, the main surgical console provides power to and controls the operation of the hand piece.

In ophthalmic surgery, for example, one hand piece is designed to allow a surgeon to perform a particular procedure, such as administering a drug to the posterior of the eye. The hand piece has a cable that provides electrical power to it. The cable attaches to a surgical console that is designed to perform many different procedures in an ophthalmic surgery. The surgeon uses the hand piece to deliver the necessary drug.

Instead of using a cable to power the hand piece, it would be desirable to have a hand piece that is battery-operated and more easily manipulated in the hand. Eliminating the cable attachment and incorporating battery power makes the hand piece more portable and less cumbersome to operate. A battery-operated hand piece can be recharged many times to perform the same procedure.

However, using battery power also raises a safety issue. A surgeon must be certain that enough power can be delivered by the battery to safely perform the procedure. In other words, the battery must be sufficiently charged to allow the procedure to be performed safely. This is especially true for high risk procedures that would harm the patient if they were interrupted. For example, if the battery in a battery-powered hand piece used to cauterize an incision is not sufficiently charged, then the use of that hand piece could harm the patient. If the hand piece ceases proper function during a cauterization procedure, then the patient could be susceptible to harmful bleeding.

Another example is the delivery of a drug to the posterior of the eye. If the battery in a battery-powered drug delivery device is not sufficiently charged and the device ceases to operate, the surgeon will have to withdraw the device and make a new insertion. Since drug delivery devices typically involve specialized needles that are inserted into the eye, the removal of one needle and the insertion of another needle can cause unnecessary trauma that could harm the patient.

A surgeon should check the batteries before each procedure in which the hand piece is used. In some hand pieces, this is not possible. The battery is integral with the hand piece, and there is no way to determine its charge level. In such a case, the hand piece must be charged before each procedure to ensure the safe operation of the hand piece during the procedure. In other hand pieces, the batteries are removable from the hand piece. In such a case, the batteries must be removed from the surgical hand piece and checked with a separate meter. This is time consuming and can lead to errors in replacing the batteries. In other devices, the battery meter remains on all of the time. This depletes the battery and could lead to improper operation of the hand piece.

It would be desirable to have a battery meter integral with a battery-powered surgical hand piece for ensuring the safe operation of the hand piece in medical procedures. It would also be desirable to have a battery meter that turns on when the hand piece is grasped and thereafter automatically turns off.

### SUMMARY OF THE INVENTION

In one embodiment consistent with the principles of the present invention, the present invention is a safety meter system for a battery-operated surgical hand piece. The system has a controller, a battery, a sensor, and a display. The controller is operably connected to the battery, the sensor, and the display. The controller is configured to read a charge level from the battery. The battery provides power to the hand piece. The sensor is configured to transmit a signal to the controller when the sensor is moved or grasped. The display provides an indication of a charge level remaining in the battery. When the controller receives the signal from the sensor, the controller is energized, reads the charge level from the battery, and displays the charge level on the display. After a period of time after the charge level is displayed, the controller and the display are turned off.

In another embodiment consistent with the principles of the present invention, the present invention is a surgical hand piece. The surgical hand piece has a body portion configured to be grasped in a hand, a display located on the body portion, a battery contained within the body portion for providing power to the hand piece, a sensor contained within the body portion configured to detect when the hand piece is moved or grasped, and a controller contained within the body portion. When the controller receives a signal from the sensor, the controller reads a status of the battery and displays the status on the display. After a period of time after the status is displayed, the hand piece is turned off.

In another embodiment consistent with the principles of the present invention, the present invention is a removable battery pack for a surgical hand piece. The removable battery pack has a housing, a battery located within the housing, a display located on the housing for indicating a status of the battery, a sensor located within the housing for detecting when the battery pack is moved or grasped, and a controller located within housing. When the controller receives a signal from the sensor, the controller reads the status of the battery and displays the status of the battery on the display. After a period of time after the status of the battery is displayed, the controller and display are turned off.

In another embodiment consistent with the principles of the present invention, the present invention is a method of safely operating a surgical hand piece. Movement or grasping of the hand piece is detected. In response, a charge level of the battery is read. The charge level is displayed on the display. After a period of time after the charge level is displayed, the display is turned off.

In another embodiment consistent with the principles of the present invention, the present invention is a method of safely operating a surgical hand piece. Movement or grasping of the hand piece is detected. In response, a status of the battery is read. Based on the status, a determination is made about whether or not it is safe to use the hand piece. If it is not safe to use the hand piece, the hand piece is deactivated.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of a battery-operated hand piece with a battery meter system according to an embodiment of the present invention.

FIG. 2 is a block diagram of a battery meter system for use with a battery-operated surgical hand piece according to an embodiment of the present invention.

FIG. 3 is a perspective view of a battery-operated hand piece with a battery meter system according to an embodiment of the present invention.

FIG. 4 is a block diagram of a battery meter system for use with a battery-operated surgical hand piece according to an embodiment of the present invention.

FIG. 5 is a perspective view of a battery-operated hand piece with a battery meter system according to an embodiment of the present invention.

FIG. 6 is a flow chart of one method of operation according to an embodiment of the present invention.

FIG. 7 is a flow chart of one method of operation according to an embodiment of the present invention.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

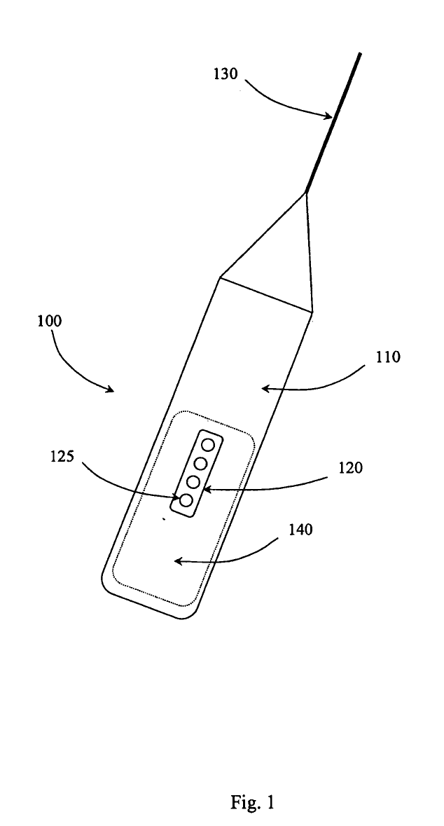

FIG. 1 is a perspective view of a battery-operated hand piece with a battery meter system according to an embodiment of the present invention. Hand piece 100 has a housing 110, an LED display 120, a working tip 130, and a battery pack 140. The LED display 120 is located on the housing 110 so that it is visible. Working tip 130 is located on one end of the hand piece 100. Battery pack 140 is located within the housing 110.

The LED display 120 is visible when looking at the body 110 of the hand piece 100. The LED display 120 contains four LEDs, such as LED 125. LED display 120 provides an indication of the charge level of battery pack 140. Alternatively, LED display 120 provides information about the status of the battery pack 140. For example, LED display 120 may be configured to provide an indication that the battery pack 140 is defective, does not have enough charge to safely perform a procedure, or that it needs to be recharged. In general, LED display 120 can be configured to provide any type of information about battery pack 140. While LED display 120 is shown as being located on the side of housing 110, it may be located on any part of housing 110. LED display 120 may also be integrated with battery pack 140.

Working tip 130 is located at one end of the hand piece above the housing 110. In one embodiment, working tip 130 is designed to be inserted into the eye during ophthalmic surgery. If hand piece 100 is a drug delivery device, then working tip 130 is a needle designed to administer a dosage of a drug to the eye. Housing 110 is designed to be held in the hand by a surgeon.

Battery pack 140 is located on the end of hand piece 100 opposite the working tip 130. Battery pack 140 typically includes one or more lithium ion batteries or cells. However, battery pack 140 may include types of batteries other than lithium ion, such as nickel cadmium batteries.

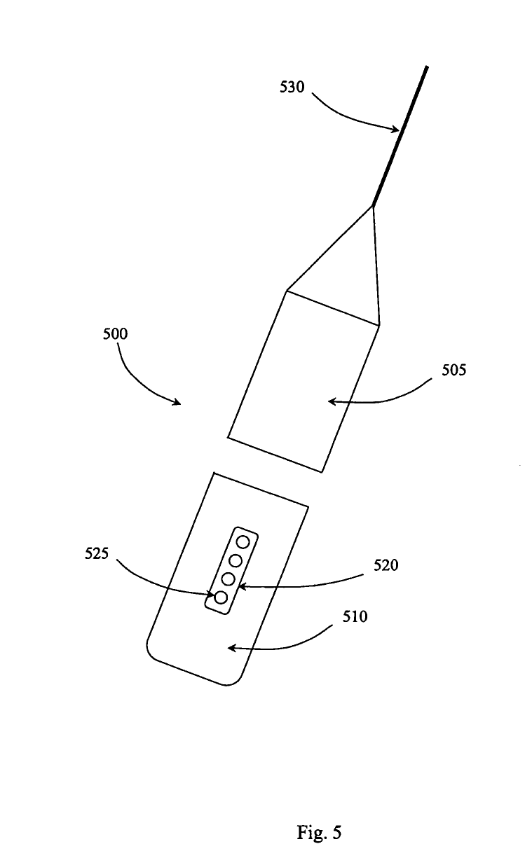

Battery pack 140 may be integrated into hand piece 100, or it may be removable from housing 110 (as shown more clearly in FIG. 5). If removable, battery pack 140 is designed to power numerous different hand pieces. In this manner, battery pack 140 is a universal battery pack for use with several different battery-powered hand pieces. In such a case, battery pack 140 has electrical and mechanical connectors (not shown) to couple the battery pack with hand piece housing 110. Likewise, housing 110 has within it electrical and mechanical connectors (not shown) designed to couple with the connectors on battery pack 140. The same connectors found in housing 110 are also found on other hand pieces designed to operate with battery pack 140. In the configuration shown in FIG. 1, battery pack 140 can be located within housing 110. Battery pack 140 may be removed from housing 110 by a door (not shown) or other similar structure.

In this system, a single battery pack can be used with different hand pieces. If the battery pack 140 is no longer operable, then a new battery pack can be coupled to the hand piece housing 110. Since batteries have limited lives, and in general, lives much shorter than the hand piece body itself, a system that uses a universal battery pack allows the hand piece housing 110 to be used for longer periods of time. In addition, it is easy to change the battery pack 140 if it is of a universal type described herein.

In the same manner, working tip 130 may be removable from the housing 110 of hand piece 100. Different working tips may be used with housing 110. In such a case, the hand piece housing 110 is a universal body for use with different working tips.

Hand piece 100 may be any type of electrically-powered surgical or medical tool. For example, hand piece 100 may be an illuminator, laser, cauterizing device, or a drug delivery device. In one embodiment, hand piece 100 is a device for injecting a drug into the posterior of an eye. The hand piece 100 contains a drive mechanism and heater that can be powered by a battery. The heater warms the drug to the proper temperature and the drive mechanism operates a plunger that delivers the drug through a needle and into the eye.

Hand piece 100 may contain control circuitry (not shown) or it may be controlled via a wireless connection to a surgical console. In one embodiment, hand piece 100 contains simple integrated circuits that can control the various functions performed by hand piece 100. For example, hand piece 100 may contain a simple circuit that controls the operation of a heater coil or a motor. Eliminating a wired connection to a main surgical console and putting all of the control circuitry and battery power in the hand piece makes for a more mobile and easy-to-use device.

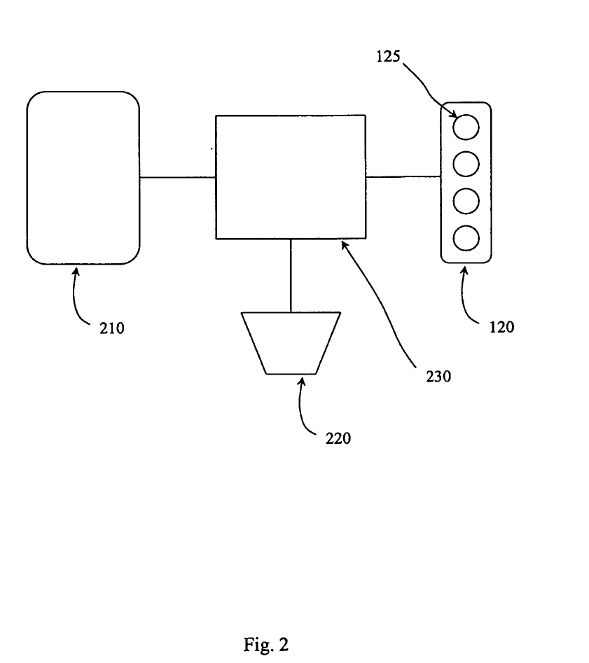

FIG. 2 is a block diagram of a battery meter system for use with a battery-operated surgical hand piece according to an embodiment of the present invention. The battery meter system includes a battery 210, a sensor 220, a controller 230, and an LED display 120. The controller 230 is operably connected to the battery 210, the sensor 220, and the LED display 120.

The battery meter system may be contained within housing 110 or it may be integrated with battery pack 140. If contained within housing 110, the battery meter system can be designed to interface with battery pack 140. In this configuration, the controller 230, sensor 220, and LED display 120 are contained within housing 110. The controller 230, sensor 220, and LED display 120 can then be used with different battery packs. If one battery pack is defective or needs to be replaced, a new battery pack can be inserted in housing 110 and used with controller 230, sensor 220, and LED display 120.

If controller 230, sensor 220, and LED display 120 are integrated into the battery pack, then controller 230, sensor 220, LED display 120, and battery 210 are contained in an integrated package. In this configuration, the entire battery pack, which includes controller 230, sensor 220, LED display 120, and battery 210, is removable from housing 110. If the battery 210 in the battery pack fails, then the entire battery pack can be removed from housing 110 and a new battery pack can be inserted in housing 110 to provide power to hand piece 100.

In another configuration, the battery pack includes controller 230, sensor 220, LED display 120, and battery 210. Battery 210 is removable from the remainder of the components in the battery pack. In this manner, while controller 230, sensor 220, LED display 120, and battery 210 are contained in an integrated package, the battery 210 is removable from that integrated package. In such a case, if the battery 210 fails, then a new battery can be inserted into the integrated package for use with controller 230, sensor 220, and LED display 120.

Regardless of the physical configuration, the battery meter system of FIG. 2 is configured to display a charge level or other status information of battery 210 on LED display 120. When sensor 220 detects the movement or grasping of the hand piece, it sends a signal to the controller 230. In response to this signal, the controller 230 reads a charge level or other status information from battery 210 and displays the charge level or other status information on LED display 120. After a fixed period of time, the controller 230 and display 220 turn off or hibernate.

The controller 230 is typically an integrated circuit that can perform logic functions. The controller 230 accepts an input from the sensor 220. This input indicates that the battery meter system has been moved or grasped. Typically, a person, such as a doctor, picks up the hand piece or battery pack thus activating the sensor 220. The sensor 220 generates an output that is received by the controller 230. This signal tells the controller 230 that the hand piece has been moved or grasped. The controller 230 is then configured to read a charge level or status from the battery 210 and to display that charge level or status on LED display 120. In this manner, the controller 230 acts as a battery meter capable of reading information from the battery 210 and displaying that information on LED display 120.

The controller 230 is also capable of performing a timing function that enables the system to hibernate when not in use. The controller 230 waits a fixed period of time and then turns itself and the LED display 120 off. In this manner, the controller 230 and LED display 120 hibernate after a fixed period of time. The fixed period of time can begin when the sensor 220 is activated or when the system is at rest (and the sensor 220 is no longer activated). For example, the controller 230 and LED display 120 may be turned off after a period of two minutes. This two minute period may begin after the sensor 220 is at rest and no longer producing an output. In such a case, the battery meter system is on when the hand piece is being moved or held, and it is turned off two minutes after the hand piece is put down or is placed in a resting position.

In another embodiment, the entire hand piece is turned off after a fixed period of time after the hand piece is at rest. In this manner, the entire hand piece hibernates after it is at rest or in an idle position, thereby conserving battery power when the hand piece is not in use.

In sum, when the hand piece is moved or grasped, the sensor 220 sends a signal to the controller 230. The controller 230 is activated or turned on. The controller 230 then reads a status of the battery 210 and displays that status on LED display 120. After a fixed period of time, the controller 230 and the LED display 120 are deactivated or turned off. In another embodiment of the present invention, the entire hand piece is deactivated a fixed period of time after the hand piece is at rest. This helps to conserve battery power.

The controller 230 may also perform a safety check on the battery 210. In this configuration, the controller determines if the battery 210 is faulty, inoperable, or has any number of problems. For example, the controller may be configured to determine an end-of-life condition in the battery. In such an end-of life condition, the battery is not able to properly hold the charge necessary to safely perform a procedure. In other fault conditions, the battery may be unable to provide any power to the hand piece.

In another configuration, the controller 230 determines if the battery 210 has enough charge to properly power the surgical hand piece. In this embodiment, the controller 230 reads the charge level of battery 210, and based on that reading, determines if the procedure can be performed safely.

Every procedure requires a certain amount of power. The battery 210 must be able to supply this amount of power in order for the procedure to be performed successfully. The controller 230 can read the charge level of the battery 210 and determine if it can supply the proper amount of power to the hand piece. If it cannot, then the controller 230 can display an indication of such on LED display 120. The controller 230 may also be configured to disable the battery pack or hand piece to prevent the procedure from being performed. In such a case, the battery pack or batteries must be changed or charged in order to safely perform the procedure.

In one embodiment, the sensor 220 is a device that detects movement and produces a signal in response. In this manner, when the sensor 220 is moved, it produces a signal that is read by the controller 230. This signal indicates that the sensor 220 has been moved. The sensor 220 can be any type of commercially available sensor. For example, sensor 220 can be a ball and contact type device or an off-the-shelf vibration sensor.

In another embodiment, the sensor 220 detects when the hand piece or battery pack is grasped by a hand. In this manner, the sensor 220 produces an output to the controller 230 when the hand piece or battery pack is grasped. For example, sensor 220 can be a capacitive type sensor. In this configuration, the sensor detects a change in capacitance that occurs when the hand piece or battery pack is grasped. In another configuration, the sensor 220 detects the heat of a human hand when the hand grasps the hand piece or battery pack.

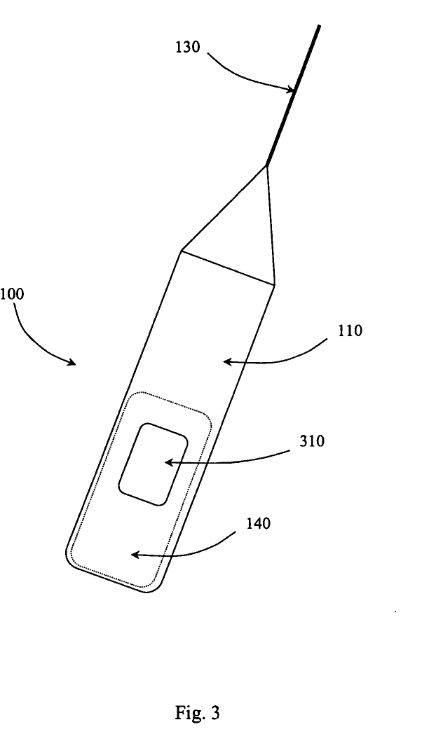

FIG. 3 is a perspective view of a battery-operated hand piece with a battery meter system according to an embodiment of the present invention. FIG. 3 is similar to FIG. 1. In FIG. 3, hand piece 300 has a housing 110, a display 310, a working tip 130, and a battery pack 140. The display 310 is located on the housing 110 so that it is visible. Working tip 130 is located on one end of the hand piece 300. Battery pack 140 is located within the housing 110.

The description and function of the embodiment of FIG. 3 is the same as that described in FIG. 1. Like components have similar characteristics and perform like functions. The only difference between FIGS. 1 and 3 is that FIG. 3 contains a display 310 while FIG. 1 contains an LED display 120.

Display 310 is capable of displaying a status of the battery pack 140. In this configuration, display 310 is a liquid crystal display (“LCD”), such as a seven segment display. Display 310, for example, can display the charge level of battery pack 140, a fault condition of battery pack 140, or an indication that it is not safe to perform the procedure.

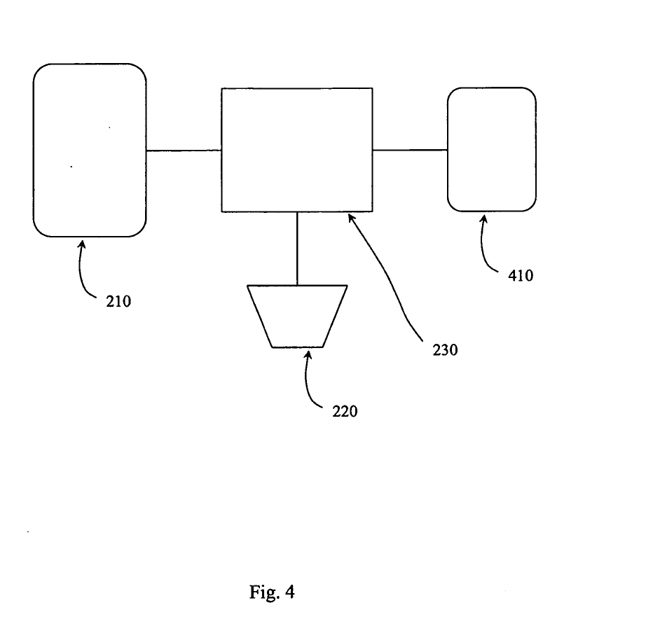

FIG. 4 is a block diagram of a battery meter system for use with a battery-operated surgical hand piece according to an embodiment of the present invention. FIG. 4 is similar to FIG. 2. The battery meter system includes a battery 210, a sensor 220, a controller 230, and a display 310. The controller 230 is operably connected to the battery 210, the sensor 220, and the display 310.

The description and function of the embodiment of FIG. 4 is the same as that described in FIG. 2. Like components have similar characteristics and perform like functions. The only difference between FIGS. 2 and 4 is that FIG. 4 contains a display 310 while FIG. 1 contains an LED display 120.

FIG. 5 is a perspective view of a battery-operated hand piece with a battery meter system according to an embodiment of the present invention. FIG. 5 is similar to FIG. 1. In FIG. 5, hand piece 500 includes a body portion 505 and a battery pack 510. The battery pack 510 is removable from the body portion 505. The battery pack 510 also includes an LED display 520 having LEDs, such as LED 525. The body portion 505 includes a working tip 530.

In this configuration, the battery pack 510 is a universal battery pack for use with several different hand pieces. In this manner, battery pack 510 can be used with hand piece body portion 505 as well as with other hand piece body portions (not shown). Battery pack 510 is designed to interface with and provide power to hand piece body portion 505. As described above, battery pack 510 is designed to mechanically and electrically couple with hand piece body portion 505. Battery pack 510 has mechanical and electrical connectors (not shown) that are designed to mate with mechanical and electrical connectors (not shown) on hand piece body portion 505.

While battery pack 510 is shown as having an LED display 520, it is understood that battery pack 510 may have any type of display. The description of hand pieces 100 and 300 of FIGS. 1 and 3 also describe various aspects of hand piece 500 in FIG. 5.

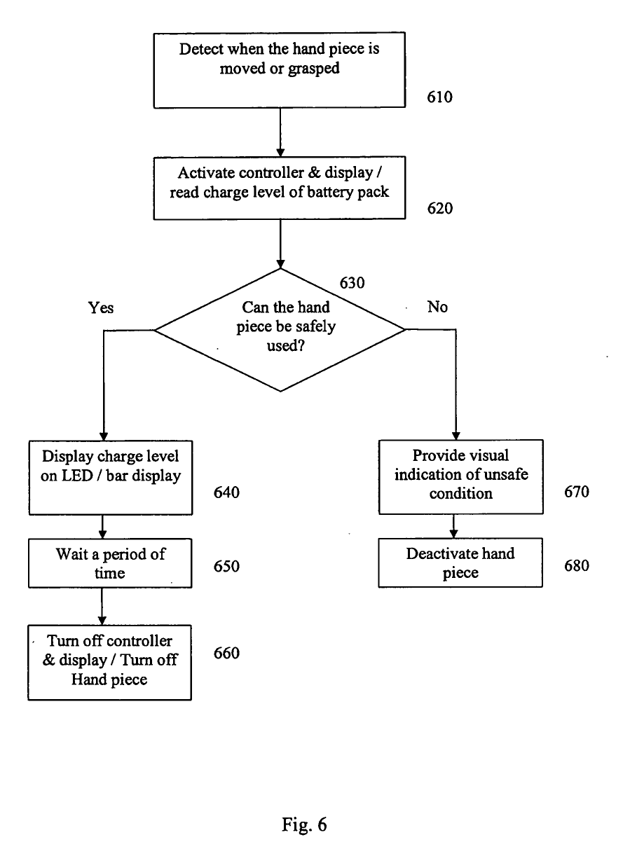

FIG. 6 is a flow chart of one method of operation according to an embodiment of the present invention. In 610, the sensor detects movement of the hand piece or detects when the hand piece is grasped. Alternatively, in the embodiment in which the sensor is integrated with a battery pack, the sensor detects movement of the battery pack or detects when the battery pack is grasped. In 620, the controller and display are activated or turned on. The controller also reads a charge level of the battery pack.

In 630, the controller determines if the hand piece can be used safely. In one embodiment, the controller compares the charge level read in 620 with a predetermined safe charge level for the procedure. Most hand pieces can perform several procedures on a single charge. Therefore, it is not necessary to fully charge the battery before each procedure. For example, one fully charged battery pack may be able to power a hand piece for eight procedures. In such a case, each procedure consumes approximately 12.5% of the battery charge. The predetermined safe charge level may be set at 25%. This ensures that the charge remaining on the battery is twice that needed to perform a procedure safely. In this case, if the controller determines that the charge level is below 25%, then the hand piece cannot be used safely.

The value for the safe charge level can be set differently for different hand pieces. Since each hand piece is designed to perform a different procedure and since different procedures require different levels of power, the safe charge level is dependent upon the type of hand piece used and the type of procedure performed. Alternatively, a single high safe charge level can be set to ensure that the battery pack has sufficient power for any procedure. This may be beneficial for a battery pack that is used with numerous different hand pieces. In such a case, a universal battery pack may provide power to different hand pieces with different power requirements.

In another embodiment, the controller determines if the hand piece can be used safely by performing a status check on the battery. This status check may be for fault conditions in the battery, end of life conditions in the battery, or other malfunctions that could prevent the battery from providing a safe level of power to the hand piece.

If the controller determines that the hand piece can be used safely, then in 640, the charge level of the battery is displayed. In the case of an LED display, the LEDs light up to show the charge level. For example, if the charge level is at 75% and there are four LEDs in the LED display, then three of the four LEDs would illuminate. Alternatively, the LEDs may have different colors indicating the charge level. For example, a green LED may illuminate indicating that it is safe to use the hand piece or that the battery is capable of providing enough power for the hand piece to be safely used for a given procedure. A red LED may indicate an unsafe condition or that the battery cannot provide enough power to the hand piece to safely perform the procedure. In the case of a liquid crystal display, the charge level may be displayed as a number, as a picture or graphic, or in any other manner.

In 650, the controller waits a period of time. This time period allows the user of the hand piece to view the charge level displayed. As mentioned, the time period may commence when the sensor detects movement or when the sensor is returned to a resting position. In the former case, picking up the hand piece starts the timing function. In the latter case, returning the hand piece to a resting position starts the timer.

In 660, the controller and display are deactivated or turned off after the period of time elapses. In this manner, the system has a hibernate function that turns off circuitry that is not necessary for the performance of a procedure. In addition, turning off the controller and display saves battery life.

Alternatively, in 660, the entire hand piece is turned off after a fixed period of time after the hand piece is at rest. In this manner, the entire hand piece hibernates after it is at rest, thereby conserving battery power when the hand piece is not in use.

If the controller determines that the hand piece cannot be used safely in 630, then in 670, a visual indication of the unsafe condition is provided. This visual indication can be in the form of illuminating a red LED, for example, in the case where an LED display is used. In another embodiment, the indication may be displayed in any manner on a liquid crystal display.

In 680, the hand piece is deactivated to prevent the hand piece from being used in an unsafe manner. For example, if the battery is faulty or cannot deliver the correct amount of power, then the hand piece is deactivated to prevent the hand piece from being used in an unsafe manner that could harm the patient. The hand piece may be deactivated by switching off the power, opening a power contact, or any other similar method.

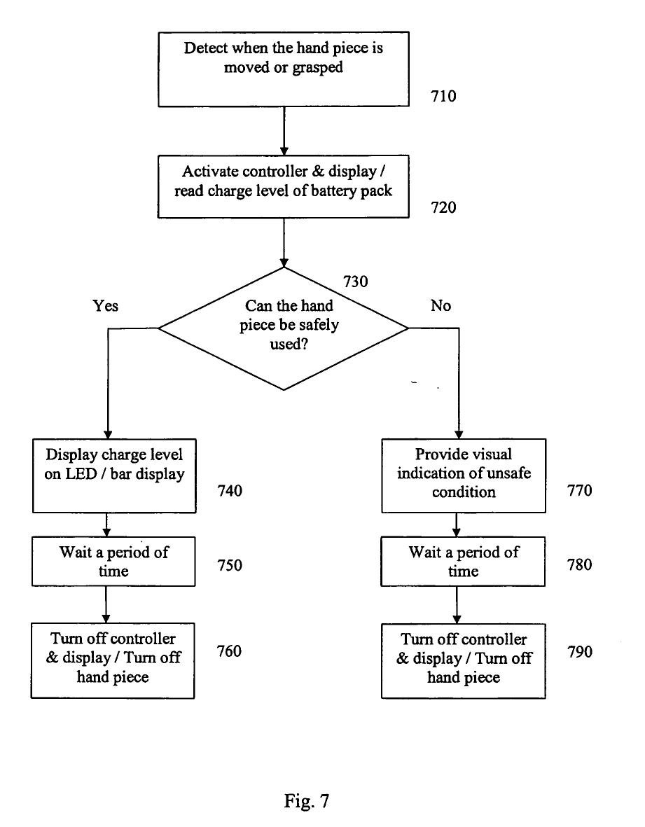

FIG. 7 is a flow chart of one method of operation according to an embodiment of the present invention. In 710, the sensor detects movement of the hand piece or detects when the hand piece is grasped. Alternatively, in the embodiment in which the sensor is integrated with a battery pack, the sensor detects movement of the battery pack or detects when the battery pack is grasped. In 720, the controller and display are activated or turned on. The controller also reads a charge level of the battery pack.

In 730, the controller determines if the hand piece can be used safely. As described in FIG. 6, in one embodiment, the controller compares the charge level read in 720 with a predetermined safe charge level for the procedure. In another embodiment, the controller determines if the hand piece can be used safely by performing a status check on the battery. This status check may be for fault conditions in the battery, end of life conditions in the battery, or other malfunctions that could prevent the battery from providing a safe level of power to the hand piece.

If the controller determines that the hand piece can be used safely, then in 740, the charge level of the battery is displayed. In 750, the controller waits a period of time. In 760, the controller and display are deactivated or turned off after the period of time elapses. Alternatively, in 760, the entire hand piece is turned off after a fixed period of time after the hand piece is at rest.

If the controller determines that the hand piece cannot be used safely in 730, then in 770, a visual indication of the unsafe condition is provided. In 780, the controller waits a period of time. In 790, the controller and display are deactivated or turned off after the period of time elapses. In this embodiment, the visual indication of the unsafe condition, such as a faulty battery or low charge level, is provided to the user of the hand piece. The user of the hand piece then knows that it should not be used. The user can then replace the battery pack or recharge it. In this manner, a battery meter is provided that allows the user of a hand piece to know when it should be charged or replaced.

From the above, it may be appreciated that the present invention provides an improved system and methods for safely operating battery-powered surgical hand pieces. The present invention provides an indication that a hand piece should not be used because of a problem with the battery. The present invention also provides a quick and efficient way of checking the charge level of a battery used in a hand piece. The present invention is illustrated herein by example, and various modifications may be made by a person of ordinary skill in the art.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A safety meter system for a battery-operated surgical hand piece comprising:
a controller configured to read a charge level from a battery operably connected to the controller, the battery for providing power to the hand piece;
a sensor operably connected to the controller, the sensor configured to transmit a signal to the controller; and
a display operably connected to the controller, the display for providing an indication of a charge level remaining in the battery;
wherein when the controller receives the signal from the sensor, the controller is energized, reads the charge level from the battery, and displays the charge level on the display; and
further wherein after a period of time after the charge level is displayed, the controller and the display are turned off.

2. The system of claim 1 wherein the controller uses the charge level to determine if it is safe to use the hand piece.

3. The system of claim 2 wherein the controller deactivates the hand piece if it is not safe to use the hand piece.

4. The system of claim 1 wherein the display contains a light emitting diode.

5. The system of claim 1 wherein the display is a liquid crystal display.

6. The system of claim 1 wherein the battery is removable from the hand piece.

7. The system of claim 1 wherein the hand piece is turned off after the period of time after the charge level is displayed.

8. The system of claim 1 wherein the sensor is a motion sensor that sends the signal to the controller when the hand piece is moved.

9. The system of claim 1 wherein the sensor sends the signal to the controller when the hand piece is grasped.

10. A surgical hand piece comprising:
a body portion configured to be grasped in a hand;
a display located on the body portion;
a battery contained within the body portion, the battery for providing power to the hand piece;
a sensor contained within the body portion; and
a controller contained within the body portion, the controller operably connected to the sensor, the battery, and the display;
wherein when the controller receives a signal from the sensor, the controller reads a status of the battery and displays the status on the display; and
further wherein after a period of time after the status is displayed, the hand piece is turned off.

11. The system of claim 10 wherein the status is a charge level of the battery.

12. The system of claim 10 wherein the controller uses the status to determine if it is safe to use the hand piece.

13. The system of claim 12 wherein the controller deactivates the hand piece if it is not safe to use the hand piece.

14. The system of claim 10 wherein the battery is removable from the hand piece.

15. The system of claim 10 wherein the sensor is a motion sensor that sends the signal to the controller when the hand piece is moved.

16. The system of claim 10 wherein the sensor sends the signal to the controller when the hand piece is grasped.

17. A removable battery pack for a surgical hand piece comprising:
a housing;
a battery located within the housing;
a display located on the housing, the display for indicating a status of the battery;
a sensor located within the housing; and
a controller located within housing, the controller operably connected to the sensor, the battery, and the display;
wherein when the controller receives a signal from the sensor, the controller reads the status of the battery and displays the status of the battery on the display; and
further wherein after a period of time after the status of the battery is displayed, the controller and display are turned off.

18. The system of claim 17 wherein the controller uses the status to determine if it is safe to use the hand piece.

19. The system of claim 18 wherein the controller deactivates the hand piece if it is not safe to use the hand piece.

20. The system of claim 17 wherein the hand piece is turned off after the period of time after the status is displayed.

21. The system of claim 17 wherein the sensor is a motion sensor that sends the signal to the controller when the hand piece is moved.

22. The system of claim 17 wherein the sensor sends the signal to the controller when the hand piece is grasped.

23. A method of safely operating a surgical hand piece comprising:
detecting when the hand piece is moved or grasped;
reading a charge level of a battery in response to the movement;
displaying the charge level on a display; and
turning off the display after a period of time after the charge level is displayed.

24. The method of claim 23 further comprising determining if it is safe to use the hand piece based on the charge level.

25. The method of claim 24 further comprising deactivating the hand piece if it is not safe to use the hand piece.

26. The method of claim 25 further comprising turning off the hand piece after the period of time after the charge level is displayed

27. A method of safely operating a surgical hand piece comprising:
detecting when the hand piece is moved or grasped;
reading a status of a battery in response to the movement;
determining if it is safe to use the hand piece based on the status; and
if it is not safe to use the hand piece, deactivating the hand piece.

28. The method of claim 27 further comprising providing a visual indication on a display that it is not safe to use the hand piece.
